(19) United States
(12) Patent Application Publication
(10) Pub. No.: US 2007/0262753 A1
(43) Pub. Date: Nov. 15, 2007

(54) SWITCHING POWER SUPPLY WITH OUTPUT RIPPLE SUPPRESSION

(75) Inventors: Sha-Sha Hu, Shenzhen (CN); Hai Lin, Shenzhen (CN); Huai-Long Wang, Shenzhen (CN); Shin-Hong Chung, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/740,283

(22) Filed: Apr. 25, 2007

(30) Foreign Application Priority Data
May 12, 2006 (CN) 200610060633.7

(51) Int. Cl. G05F 1/70

(52) U.S. Cl. 323/207

(57) ABSTRACT

A switching power supply with output ripple suppression includes a rectification circuit, a filtering circuit, a PFC, a transformer, a voltage stabilization circuit and a DC/DC converting circuit with feedback control. The DC/DC converting circuit includes a switching circuit, a PWM generator and a feedback circuit. The feedback circuit receiving feedback signals reflects an actual output voltage of the switching power supply and transmits the feedback signals to the PWM generator. The PWM generator produces PWM waves to control an on-off time ratio of the switching circuit by comparing the feedback signals with a reference signal that reflects a desired output voltage of the switching power supply. The switching circuit in turn controls the actual output voltage of the switching power supply.

### BACKGROUND

1. Technical Field

The present invention relates to switching power supply, and particularly to a switching power supply capable of suppressing output ripple.

2. Related Art

Referring to FIG. 4, a schematic diagram of a traditional switching power supply is shown. The switching power supply 1 is interposed between an AC (alternating current) source 1 and a DC (direct current) load, and employs an EMI (Electromagnetic Interference) filter 20, a rectification circuit 20, a filtering circuit 40, a transformer 50, and a voltage stabilization circuit 70 connected in series between the AC source 1 and the DC load. A PFC (power factor controller) 60 receives power supply outputted from the rectification circuit 40 for it's normal operation. The PFC 60 is connected to a primary winding of the transformer 50 and is employed to adjust a power transfer rate of the switching power supply 1 according to feedback from the transformer 50, thus increasing an output stabilization of the switching power supply 1.

When stabilizing the output of the switching power supply 1, the PFC 60 also increases output ripple of the switching power supply 1. The PFC 60 employs an electronic switch such as a MOS transistor (not shown) and controls the electronic switch to switch on and off alternately. The switch operations of the electronic switch produces a lot of ripples, and reduces an output quality of the switching power supply 1.

Therefore, there is a need for providing a switching power supply with ripple suppression to resolve the problem existed in the related art.

### SUMMARY

A switching power supply with ripple suppression is provided with a preferred embodiment, the switching power supply includes a rectification circuit, a filtering circuit, a PFC, a transformer, a voltage stabilization circuit and a DC/DC converting circuit with feedback control. The DC/DC converting circuit includes a switching circuit, a PWM generator and a feedback circuit. The feedback circuit receiving feedback signals reflects an actual output voltage of the switching power supply and transmits the feedback signals to the PWM generator. The PWM generator produces PWM waves to control a on-off time ratio of the switching circuit by comparing the feedback signals with a reference signal that reflects a desired output voltage of the switching power supply. The switching circuit in turn controls the actual output voltage of the switching power supply.

Other advantages and novel features will be drawn from the following detailed description with reference to the attached drawings, in which:

### BRIEF DESCRIPTION OF THE DRAWINGS

FIG. 1 is a schematic block diagram of a switching power supply with ripple suppression in accordance with a preferred embodiment of the present invention;

FIG. 2 shows a circuit diagram of a DC/DC converting circuit of the switching power supply of FIG. 1;

FIG. 3 shows an alternative circuit diagram of the DC/DC converting circuit; and

FIG. 4 is a schematic block diagram of a traditional switching power supply of the related art.

### DETAILED DESCRIPTION OF THE EMBODIMENTS

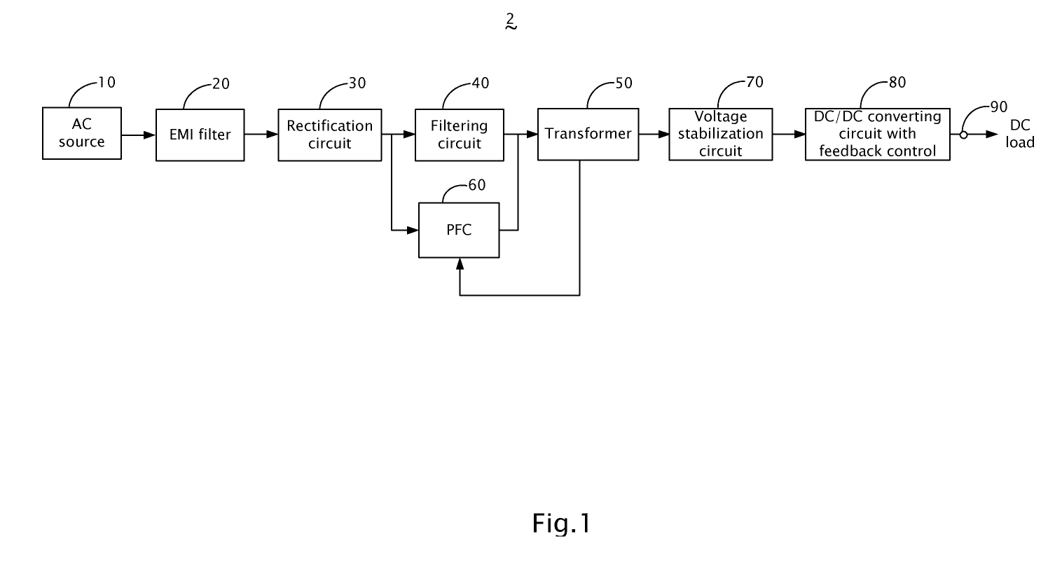

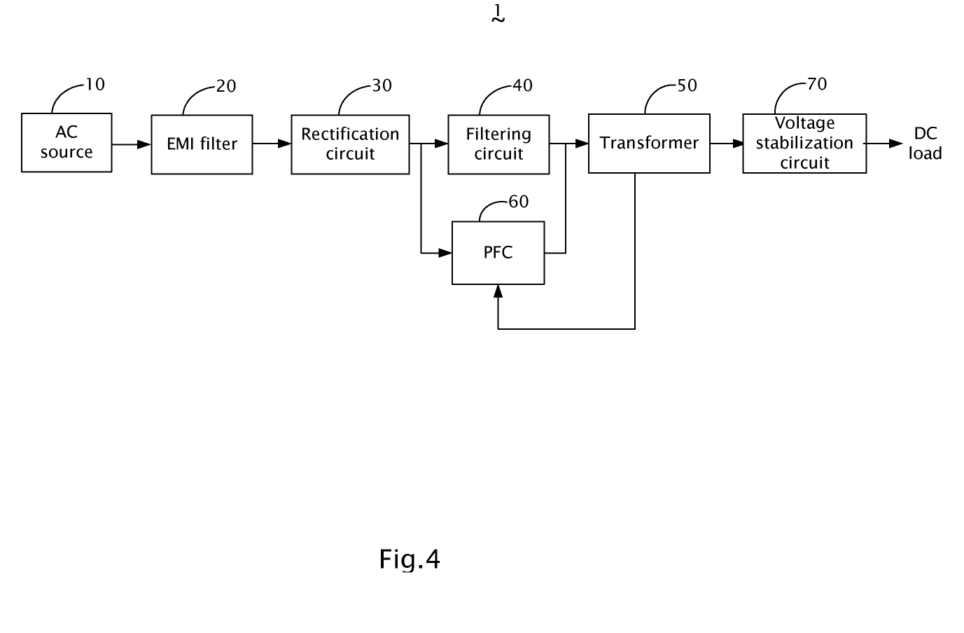

Referring to FIG. 1, a schematic diagram of a switching power supply with ripple suppression is shown. As Compared with the traditional switching power supply shown in FIG. 4, the switching power supply 2 further includes a DC/DC (direct current-to-direct current) converting circuit 80. The DC/DC converting circuit 80 is connected in series with the voltage stabilization circuit 70 in the switching power supply 2 and executes a DC-to-DC power conversion before output DC power to the DC load. The DC/DC converting circuit 80 is provided with a feedback control function that is used for stabilizing an output voltage to the DC load according to feedback signals from the output voltage, thus reducing ripples that exist in the output voltage.

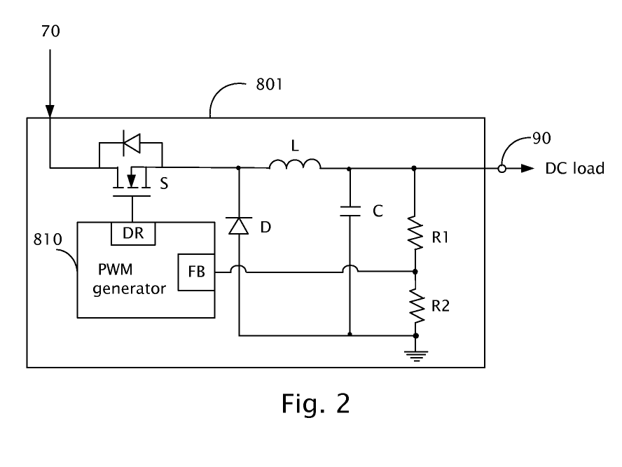

Referring to FIG. 2, an exemplary circuit diagram of the DC/DC converting circuit 80 is shown. The DC/DC converting circuit 80 of FIG. 1 embodied in FIG. 2 is a buck converting circuit 801 and includes a switching circuit S connected between the voltage stabilization circuit 70 and an output terminal 90 of the switching power supply 2. The output terminal 90 is used for connecting the switching power supply 2 with the DC load. As shown in FIG. 2, the switching circuit is presented using a MOS (Metal-Oxide-Semiconductor) transistor S that is controlled by a PWM (pulse width modulation) generator 810. The PWM generator 810 includes a driving signal output port DR and a feedback signal receiving port FB. The driving signal output port DR is connected with the MOS transistor S and the feedback signal receiving port FB is connected to a feedback circuit. The feedback circuit is actually a voltage dividing circuit as presented in FIG. 2. The voltage dividing circuit is made up with two resistors R1 and R2. The resistors R1 and R2 are serially connected between the output terminal 90 of the switching power supply 2 and ground. The feedback signal receiving port FB of the PWM generator 810 is connected between the resistors R1, R2 and receives feedback signals from the voltage dividing circuit. The feedback signals reflect the actual output voltage to the DC load. The PWM generator 810 generates PWM waves to control an on-off time ratio of the switching circuit S by comparing the feedback signals to a reference signal that reflects a desired output voltage.

Also referring to FIG. 2, an inductor L is connected between the switching circuit S and the output terminal 90 of the switching power supply 2. A diode D and a capacitor C are connected on opposite sides of the inductor L. Concretely, the diode D is inversely connected between the switching circuit S and ground, and the capacitor C is connected between the output terminal 90 of the switching power supply 2 and ground. The capacitor C filters the ripples in the output voltage.

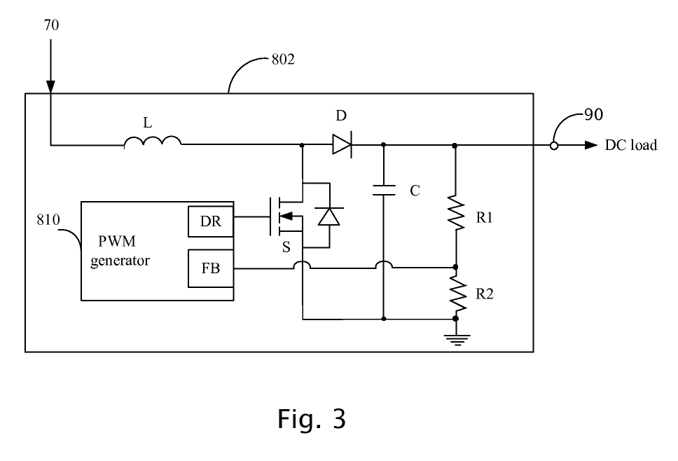

Referring to FIG. 3, an alternative exemplary circuit diagram of the DC/DC converting circuit 80 is shown. The DC/DC converting circuit 80 in FIG. 3 is a boost converting circuit 802. The inductor L and the diode D are serially connected between the voltage stabilization circuit 70 and the output terminal 90 of the switching power supply 2. The inductor L is connected with an anode of the diode D. The switching circuit S and the capacitor C are connected on opposite sides of the diode D, concretely, the switching circuit S is connected between the anode of the diode D and the ground, and the capacitor C is connected between a cathode of the diode D and the ground.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A switching power supply with output ripple suppression comprising a rectification circuit, a filtering circuit, a PFC, a transformer, a voltage stabilization circuit, and a DC/DC converting circuit with feedback control, the DC/DC converting circuit comprising a switching circuit, a PWM generator, and a feedback circuit, the feedback circuit receiving feedback signals reflecting an actual output voltage of the switching power supply and transmitting the feedback signals to the PWM generator, the PWM generator producing PWM waves to control an on-off time ratio of the switching circuit by comparing the feedback signals with a reference signal that reflects a desired output voltage of the switching power supply, and the switching circuit in turn controlling the actual output voltage of the switching power supply.

2. The switching power supply as claimed in claim 1, wherein the feedback circuit is a voltage dividing circuit connected between an output terminal of the switching power supply and ground.

3. The switching power supply as claimed in claim 2, wherein the DC/DC converting circuit comprises a capacitor connected between the output terminal and ground.

4. The switching power supply as claimed in claim 2, wherein the DC/DC converting circuit is a buck converting circuit and the switching circuit is connected between the voltage stabilization circuit and the output terminal.

5. The switching power supply as claimed in claim 4, wherein the DC/DC converting circuit comprises an inductor connected between the switching circuit and the output terminal.

6. The switching power supply as claimed in claim 2, wherein the DC/DC converting circuit is a boost converting circuit and the switching circuit is connected between the voltage stabilization circuit and ground.

7. The switching power supply as claimed in claim 6, wherein the DC/DC converting circuit further comprises an inductor connected between the voltage stabilization circuit and the output terminal.
